(19) United States
(12) Patent Application Publication
(10) Pub. No.: US 2001/0042946 A1
(43) Pub. Date: Nov. 22, 2001

(54) Manufacturing process for a plastic injection molding laminated with textile fabric, non-woven or the like

(75) Inventors: Frank Schlieber, Burgbrohl (DE); Joachim Kretschmer, Kierspe (DE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Montaplast GmbH

(21) Appl. No.: 09/736,096

(22) Filed: Dec. 13, 2000

(30) Foreign Application Priority Data
Dec. 13, 1999 (DE) 199 60 054.6

(51) Int. Cl. B29C 45/14; B29C 45/16

(52) U.S. Cl. 264/511; 264/257; 264/135; 264/138

(57) ABSTRACT

In order to reduce the throughput times of a manufacturing process and the space required for the manufacturing facilities for a plastic injection molding that is laminated with a textile fabric, a non-woven or the like, particularly a piece of interior trim for an automobile, a process is provided comprising the following steps: loading of a fabric blank, which is coated on a first side facing the injection molding with a plastic film that is thermoformable and, when cooled, dimensionally stable and elastic; preforming the fabric blank into the desired outer contour of the injection molding to be manufactured; inserting the preformed fabric blank into the injection mold; injection-backing the fabric blank with plastic; and ejecting the laminated injection molding.

### BACKGROUND OF THE INVENTION

The invention relates to a manufacturing process for a plastic injection molding laminated with a textile fabric, a non-woven or the like, and a textile fabric, a non-woven or the like for laminating and permanent joining to a piece of plastic interior trim of any shape, particularly for the automotive sector.

Polyester or blended fabrics are preferably used as the textile fabrics and permanently applied to the injection molding as cladding. These materials are usually textile fabrics laminated with a non-woven. It is known from the prior art that these laminated textile fabrics are initially cut to size and the blank then placed inside the injection mold. In order to obtain a wrinkle-free surface, the fabric must be tension-mounted inside the injection mold. This is preferably achieved using a pneumatically actuated clamp system. After tension-mounting the fabric—a relatively time-consuming process—a backing is then injection molded onto it. After the injection process ends, the semi-finished workpiece, such as a column trim panel for the passenger car sector, is ejected and conveyed to the trimming station. In the trimming station, the fabric protruding over the edge of the workpiece must be trimmed in order to obtain the finished workpiece.

The workpieces are generally of three-dimensional geometry, meaning that the edge contour is also three-dimensional. According to the prior art, trimming requires an article-specific trimming cell, which can process the respective edge contour of the workpiece. The throughput time of an individual workpiece is decisively dependent on the operating speed of the injection molding machine, as this is usually the bottleneck in the manufacturing process.

The invention is based on the technical problem of further developing a generic manufacturing process such that the throughput times are reduced.

### BRIEF SUMMARY OF THE INVENTION

According to the invention, the object is solved in that the manufacturing process comprises the following steps:

Preforming of a fabric blank, which is coated on a first side facing the injection molding with a plastic film that is thermoformable and, when cooled, dimensionally stable and elastic, into the desired outer contour of the injection molding to be manufactured.

Insertion of the preformed fabric blank into the injection mold,

Injection-backing of the fabric blank with plastic, and

Ejection of the laminated injection molding.

Prior to the start of the actual injection molding process, the fabric blanks are consequently already given the prefabricated contour they need to cover the finished injection molding. In contrast to the prior art, a first side of the fabric on the inside of the finished product is provided with a thermoformable plastic. In the first process step, the fabric blank is thermoformed in a corresponding mold, in order to obtain the desired outer contour of the later injection molding. This plastic is dimensionally stable after cooling. At the same time, however, it is still so elastic that a bend can be formed with the fabric on the workpiece.

Contour trimming can be carried out after the preformed textile blanks cool. This can be done by an automatic machine, such as an articulated robot. This makes it possible to realize the three-dimensional contour trimming of the edge profile that is particularly common on interior trim in the automotive sector and cannot be realized with the simple thermoforming process step alone; in the case of thermoforming, trimming can only achieve a two-dimensional edge cut.

After contour trimming, the preformed fabric is inserted into the injection mold. The plastic film is impermeable to air, meaning that the fabric can also be handled from the fabric side by the suction grippers usually used in injection molds, in order to be inserted into the injection mold or removed from it. Thus, the usual automatic machines or robots can be used for handling in the process according to the invention without refitting.

The preformed fabric is injection-backed with plastic in the injection mold in the familiar manner. During injection molding, the injected plastic is permanently joined to the plastic film already provided on the fabric.

After injection molding, the laminated workpiece is removed from the injection mold and ejected. Accordingly, no further trimming of the workpiece is required. This initially makes continuous manufacturing possible, as the process is no longer dependent on the cycle times of the injection mold. In addition, article-specific trimming cells are unnecessary, this substantially reducing the space required for the manufacturing process. Furthermore, the fabric blanks are easy to handle, thus making it possible to realize far higher capacity utilization.

The preformed fabric blank is preferably first cut to fit the outer contour of the finished workpiece. This can be carried out by a trimming robot, for example. The article-specific trimming cells of the prior art thus become obsolete. The trimming robots can carry out any required trimming.

According to the invention, the plastic film is made of materials that can be joined particularly well with the plastic to be injected later on. Thermoplastic olefins, variants thereof, or thermoplastic urethanes are preferred for use.

Alternatively, the surface of the film facing the fabric can also be coated with an activator that permanently joins the fabric to the injected plastic and also simplifies and accelerates the joining process.

The thickness of the laminated fabric is usually about 5 mm and that of the plastic film about 2 mm. Depending on the application, the latter dimensions can also be thicker if complicated contours have to be reproduced.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a schematic top view of the manufacturing process according to the invention; and

FIG. 2 is a lateral cross-section of the textile fabric according to the invention.

### DETAILED DESCRIPTION OF THE INVENTION

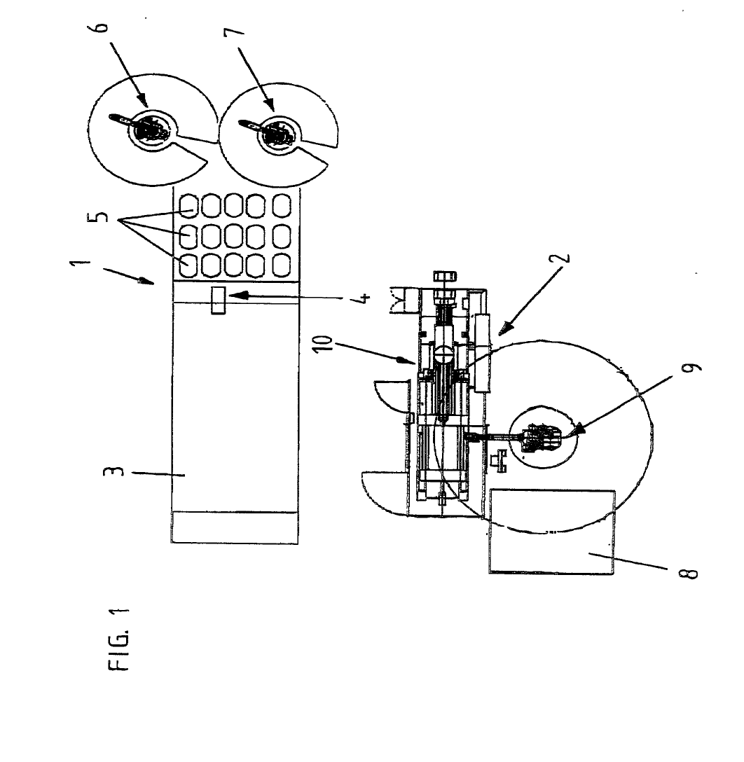

FIG. 1 shows a top view of the manufacturing process according to the invention. According to the drawing, the process essentially consists of two elements, namely thermoforming station 1 and injection molding station 2.

According to the process of the invention, laminated fabric 3, which is delivered in prefabricated form and provided with the plastic film on one side, is delivered in rolls and unrolled on thermoforming station 1. A thermoforming device, which is preferably designed as automatic thermoforming machine 4, preforms the fabric into preformed fabric blanks 5.

Trimming robots 6 and 7 cut fabric blanks 5 to the final outer contour they will have on the finished workpiece. In this case, trimming robots 6 and 7 are designed as articulated robots.

The preformed and trimmed preforms are then conveyed to an intermediate buffer 8. The individual fabric blanks 5 are conveyed from this intermediate buffer 8 by another automatic machine, which is preferably designed as a linear robot 9 due to the required precision, to the actual injection molding process in injection molding machine 10. After injection molding, the laminated workpieces are ejected from injection mold 10 by articulated robot 9 and forwarded to assembly.

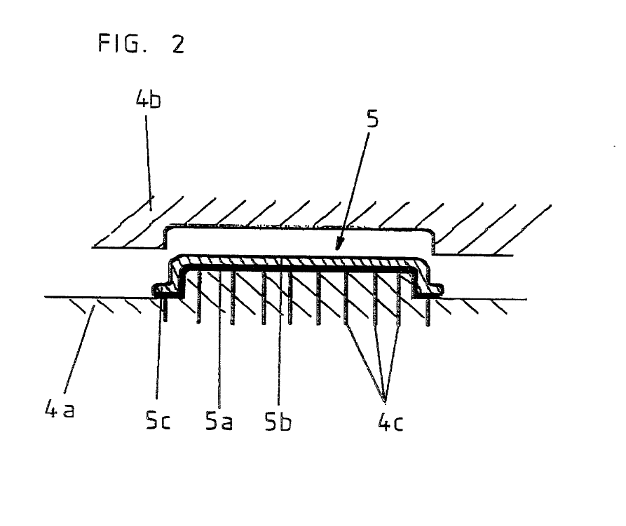

FIG. 2 shows a lateral view of a fabric blank 5 shortly after thermoforming. Thermoforming is carried out in an automatic thermoforming machine 4, which consists in the known fashion of a bottom force 4a and a top force 4b. Heat is applied to the top force and, when bottom force 4a and top force 4b are pressed together, it thermoforms plastic film 5a provided on fabric blank 5.

Plastic film 5a lies on the bottom force. Vacuum ducts 4c are also provided on bottom force 4a. Fabric blank 5 consists of a plastic film 5a lying on bottom force 4a, the underside of which is joined to a textile fabric 5b laminated with a non-woven.

After preforming, fabric blank 5 has a three-dimensional, shell-type shape. The flange-like edge 5c around the outside can either be removed during contour trimming or folded in towards the inside of the finished workpiece, if a workpiece with a fold is to be manufactured.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### List of reference numbers

1 Thermoforming station

2 Injection molding station

3 Textile fabric

4 Automatic thermoforming machine

4a Bottom force

4b Top force

4c Vacuum ducts

5 Fabric blank

5a Plastic film

5b Textile fabric

5c Edge

6 Trimming robot

7 Trimming robot

8 Intermediate buffer

9 Articulated robot

10 Injection mold

We claim:

1. A manufacturing process for a plastic injection molding laminated with a fabric, the process comprising the following steps: preforming a fabric blank into a desired outer contour of the injection molding to be manufactured, the blank being coated on a first side facing the injection molding with a plastic film that is thermoformable and, when cooled, dimensionally stable and elastic; inserting the preformed fabric blank into an injection mold; injection-backing the fabric blank with plastic; and ejecting the laminated injection molding.

2. The manufacturing process according to claim 1, wherein the preforming step is followed by trimming the fabric blank to a true-to-size contour.

3. The manufacturing process according to claim 1, wherein workpieces are exclusively handled by automatic machines between individual process steps.

4. The manufacturing process according to claim 1, wherein an edge of the injection molding has a contour of any shape.

5. The manufacturing process according to claim 4, wherein the shape is three-dimensional.

6. The manufacturing process according to claim 1, wherein the injection molding is a piece of interior trim for an automobile.

7. A textile fabric for laminating and permanent joining to a piece of plastic interior trim of any shape, comprising a fabric joined on one side to a plastic film (5a) that is thermoformable and, when cooled, dimensionally stable and elastic.

8. The textile fabric according to claim 7, wherein a surface of the plastic film (5a) facing the fabric is coated with an activator that permanently joins the fabric to the plastic to be used for injection-backing.

9. The textile fabric according to claim 7, wherein the trim is for use in an automotive sector.
